(19) United States
(12) Patent Application Publication
(10) Pub. No.: US 2008/0247860 A1
(43) Pub. Date: Oct. 9, 2008

(54) Hydroelectric power plant and method of generating power

(76) Inventor: Timothy Cresci, Bal Harbour, FL (US)

Correspondence Address: ANDREW F. KNIGHT, 124 SOUTHAMPTON DRIVE, VINTON, VA, 24179, US

(21) Appl. No.: 12/009,442

(22) Filed: Jan. 18, 2008

Related U.S. Application Data
(63) Continuation-in-part of application No. 11/732,917, filed on Apr. 6, 2007.
(60) Provisional application No. 60/994,978, filed on Sep. 24, 2007.

(51) Int. Cl. F03B 13/10

(52) U.S. Cl. 415/1; 415/202

(57) ABSTRACT

A hydroelectric power plant includes a fluid intake, a fluid exhaust, a fluid engine located in a fluid path between the fluid intake and the fluid exhaust, and a fluid accelerating device located adjacent to the fluid exhaust. The fluid accelerating device is configured to accelerate fluid past the fluid exhaust and is approximately shaped as a portion of a cone.

### REFERENCE TO RELATED APPLICATIONS

The present application is a Continuation-in-Part of U.S. patent application Ser. No. 11/732,917, filed Apr. 6, 2007, entitled, “Hydroelectric Power Plant and Method of Generating Power,” the disclosure of which is hereby incorporated by reference. The present application also claims priority to U.S. Provisional Application No. 60/994,978 filed Sep. 24, 2007, entitled “Mathematical Model for Hydroelectric Exhaust Powered by Down Current Cone.”

### BACKGROUND

Power is often extracted from moving water by either damming the water (i.e., effectively stopping the water) and taking advantage of a flow of water downward from the dam, or by using a turbine within a water flow.

### SUMMARY OF THE INVENTION

One problem with the former solution is that power is most efficiently extracted from moving water by not having to stop and then re-accelerate the water. One problem with the latter solution is that harsh water environments (such as silt, mud, salt, etc.) often cause fouling and regular maintenance of the turbines. The present invention aims to solve at least one of these and other problems.

In one embodiment, a hydroelectric power plant comprises: a fluid intake; a fluid exhaust; a fluid engine located in a fluid path between the fluid intake and the fluid exhaust; and a fluid accelerating device located adjacent to the fluid exhaust and configured to accelerate fluid past the fluid exhaust, wherein the fluid accelerating device is approximately shaped as a portion of a cone.

In one aspect, the hydroelectric power plant comprises a plurality of fluid exhausts and a plurality of fluid accelerating devices, each fluid accelerating device approximately shaped as a portion of a cone and located adjacent to at least one of the plurality of fluid exhausts.

In one aspect, the plant further comprises a wedge located adjacent to the fluid intake, wherein the wedge comprises at least upper and lower surfaces, the upper and lower surfaces angled with respect to each other by at least approximately 15°. In one aspect, the wedge further comprises a flow constriction device configured to increase a velocity of the fluid flow, wherein the flow constriction device comprises at least two sides connected to the upper surface and extending above the upper surface, wherein the at least two sides taper toward each other in a direction approaching the fluid intake.

In one aspect, the fluid accelerating device is located directly adjacent to the wedge. In one aspect, the fluid accelerating device is located remotely from the wedge. In one aspect, the fluid path comprises an inverted siphon.

In one aspect, the plant further comprises a second fluid accelerating device comprising a back connected to a corresponding back of said fluid accelerating device and configured to accelerate fluid past the fluid exhaust, wherein the second fluid accelerating device is approximately shaped as a portion of a cone.

According to an embodiment of the present invention, a hydroelectric power plant comprises: a fluid intake; a fluid exhaust; a wedge located adjacent to the fluid intake, the wedge comprising at least upper and lower surfaces, the upper and lower surfaces angled with respect to each other by at least approximately 15°; a fluid accelerating device located adjacent to the fluid exhaust and configured to accelerate fluid past the fluid exhaust; and a fluid engine located in a fluid path between the fluid intake and the fluid exhaust, wherein the wedge comprises a flow constriction device configured to increase a velocity of the fluid flow, wherein the flow constriction device comprises at least two sides connected to the upper surface and extending above the upper surface, and wherein the at least two sides taper toward each other in a direction approaching the fluid intake.

In one aspect, the hydroelectric power plant comprises a plurality of fluid exhausts and a plurality of fluid accelerating devices, each fluid accelerating device located adjacent to at least one of the plurality of fluid exhausts, and a plurality of fluid intakes and a plurality of wedges, each wedge located adjacent to at least one of the fluid intakes.

In one aspect, the fluid accelerating device is located directly adjacent to the wedge. In one aspect, the fluid accelerating device is located remotely from the wedge. In one aspect, the fluid path comprises an inverted siphon.

In one aspect, the plant further comprises a second fluid accelerating device comprising a back connected to a corresponding back of said fluid accelerating device and configured to accelerate fluid past the fluid exhaust.

According to an embodiment of the present invention, a method of generating electricity comprises: providing a hydroelectric power plant, the plant comprising: a fluid intake; a fluid exhaust; a wedge located adjacent to the fluid intake; a fluid accelerating device located adjacent to the fluid exhaust and configured to accelerate fluid past the fluid exhaust; and a fluid engine located in a fluid path between the fluid intake and the fluid exhaust, wherein the wedge comprises at least upper and lower surfaces, the upper and lower surfaces angled with respect to each other by at least approximately 15°; inserting the wedge into a first body of water; and inserting the fluid accelerating device into a second body of water different than the first body of water.

In one aspect, the fluid accelerating device is approximately shaped as a portion of a cone. In one aspect, the hydroelectric power plant comprises a plurality of fluid accelerating devices, each fluid accelerating device approximately shaped as a portion of a cone.

In one aspect, the hydroelectric power plant comprises a plurality of wedges, each wedge comprising at least upper and lower surfaces, the upper and lower surfaces angled with respect to each other by at least approximately 15°.

In one aspect, the method further comprises inserting the fluid accelerating device into the second body of water more deeply than the wedge is inserted into the first body of water. In one aspect, the method further comprises rotating at least one of the fluid accelerating device and wedge to account for a flow direction in the first or second body of water.

### BRIEF DESCRIPTION OF THE DRAWINGS

FIG. 1a shows a side view of a power plant according to an embodiment.

FIG. 1b shows a side view of a power plant according to another embodiment.

FIG. 1c shows a side view of a power plant according to another embodiment.

FIG. 2 shows a side view of a power plant according to another embodiment.

FIG. 3 shows a side view of a power plant according to another embodiment.

FIG. 4a shows a perspective view of a power plant according to another embodiment.

FIG. 4b shows a side view of the power plant shown in FIG. 4a.

FIG. 4c shows a perspective view of a power plant according to another embodiment.

FIG. 5 shows a fluid engine according to an embodiment.

FIG. 6a shows a side view of a power plant according to another embodiment.

FIG. 6b shows a side view of a power plant according to another embodiment.

FIG. 7a shows a side view of a portion of a power plant according to an embodiment.

FIG. 7b shows a perspective view of a portion of a power plant according to an embodiment.

FIG. 7c shows a side view of the portion shown in FIG. 7b.

FIG. 8 shows a perspective view of a power plant according to another embodiment.

FIG. 9 shows a perspective view of a power plant according to another embodiment.

FIG. 10 shows a cross sectional view of a power plant according to another embodiment.

FIG. 11 shows a cross sectional view of a power plant according to another embodiment.

FIG. 12 shows a cross sectional view of a power plant according to another embodiment.

FIG. 13 shows a cross sectional view of a power plant according to another embodiment.

### DETAILED DESCRIPTION

In the following description, the use of “a,” “an,” or “the” can refer to the plural. All examples given are for clarification only, and are not intended to limit the scope of the invention.

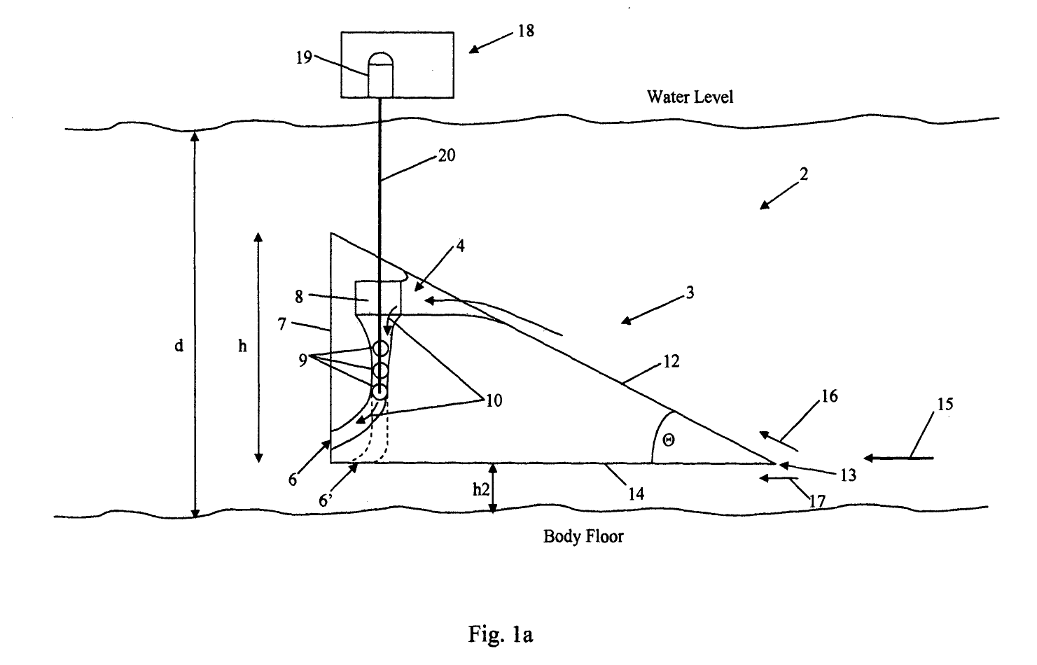

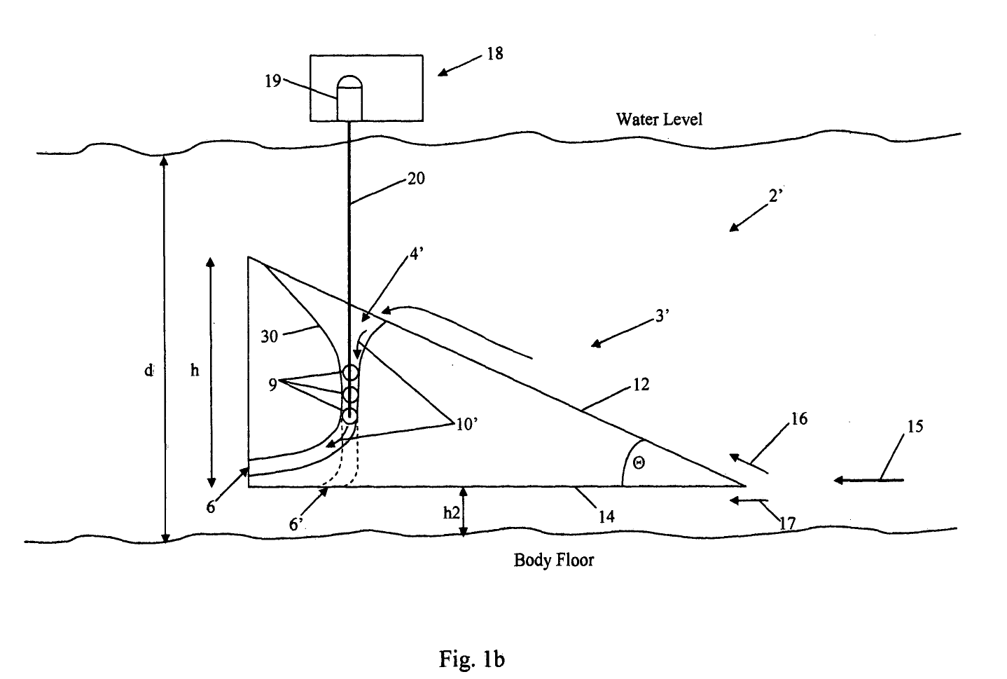

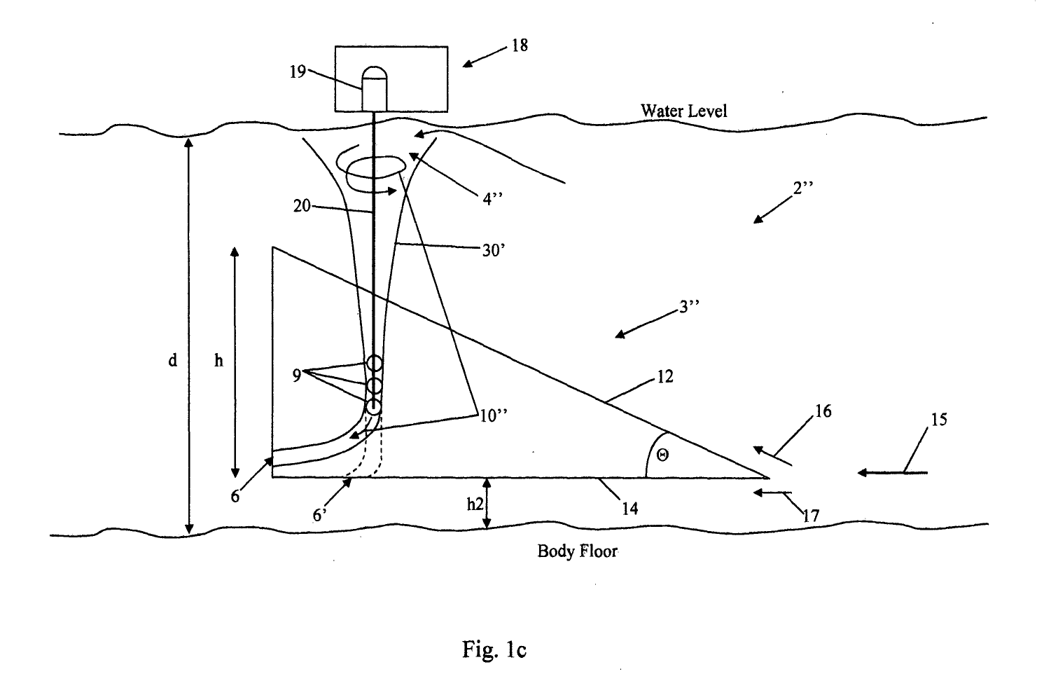

Referring now to FIG. 1a, a power plant 2 comprises a wedge 3 connected to a generating station 18 via a shaft 20. The generating station 18 includes at least one electrical generator 19, such as a generator that converts rotational energy to electricity, as known in the art. The wedge 3 is located within a body of water having a Body Floor and a Water Level, and comprises an upper surface 12 and a lower surface 14, the surfaces 12, 14 angled with respect to each other by angle Θ. The body of water has a current having a fluid flow 15. The angle Θ may be at least approximately 15°, preferably ranges from approximately 30 to 60°, and more preferably ranges from approximately 40 to 50°. The upper surface 12 may be adjustable with respect to the lower surface 14 so that the angle Θ can be changed, such as from 40° to 50° upon a slowing of the speed of fluid flow 15. One of ordinary skill in the art will understand how to make surfaces 12, 14 adjustable with respect to each other. For example, wedge point 13 could be hinged and a hydraulically acting piston connecting opposing ends of the upper and lower surfaces 12, 14 could raise or lower one with respect to the other.

The wedge 3 further comprises a fluid intake 4 and a fluid exhaust 6, and at least one engine 8, 9 located between the fluid intake 4 and the fluid exhaust 6 in a fluid path 10 inside the wedge 3. The wedge 3 is shaped to divide the fluid flow 15 of the body of water into at least a first flow portion 16 and a second flow portion 17, and to receive at least a portion of the first flow portion 16 in the fluid intake 4.

The wedge 3 is located in the body of water a height h2 from the Body Floor, which height h2 may range from approximately 5 to 30 feet, and more preferably from about 10 to 20 feet. The wedge 3 has a height h that ranges from approximately 10 to 100 feet, and more preferably from approximately 20 to 30 feet. The ratio of the height h of the wedge 3 to a depth d of the body of water may range from approximately 0.2 to 0.8, and more preferably from approximately 0.4 to 0.6.

In FIG. 1a, fluid intake 4 allows at least a portion of the first flow portion 16 to flow approximately horizontally into a first fluid engine 8. The first fluid engine 8 may be a tangential fluid engine having a rotor and an approximately vertical axis (i.e., vertical as shown in FIG. 1a), whereby the engine 8 is configured to convert kinetic energy of a fluid impinging tangentially on the rotor to rotational kinetic energy of the rotor. Another feature of a tangential fluid engine may be that the rotor spins on an axis that is approximately perpendicular to a vector of the moving fluid. One such tangential fluid engine is a Pelton wheel, as known in the art, but other examples of tangential fluid engines are within the scope of the present invention.

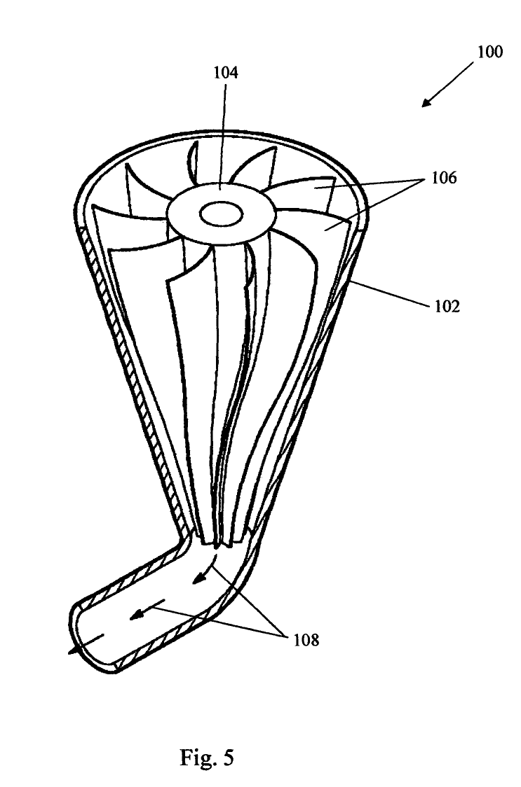

Engines 9 may comprise axial fluid engines, each having a rotor having an approximately vertical axis (i.e., vertical as shown in FIG. 1a), whereby the axial fluid engine is configured to convert kinetic energy of water impinging axially on the rotor to rotational kinetic energy of the rotor. Another feature of an axial fluid engine may be that the rotor spins on an axis that is approximately parallel to a vector of the moving fluid. One such axial fluid engine is an axial turbine, but other examples, such as the suction propeller described with reference to FIG. 5, are within the scope of the present invention.

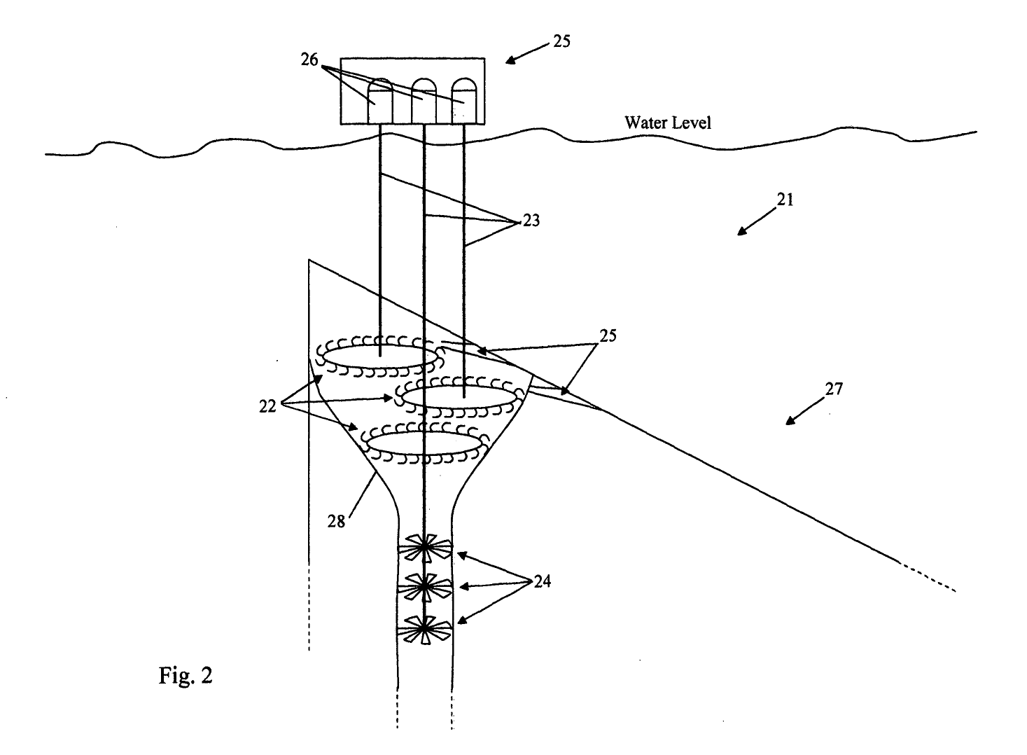

The engines 8, 9 in FIG. 1a are shown sharing a common shaft or axle 20, connecting the engines to the electrical generator 19. In one embodiment, the rotors of each of engines 8, 9 are directly connected to each other via the axle 20, but in other embodiments: a) rotors of some engines are connected to each other via gears and/or gear boxes, so that differential rotation rates of the respective rotors can be accommodated; or b) the power plant includes multiple axles (such as will be discussed with reference to FIG. 2), and only some of the rotors are directly connected to each other.

In one embodiment, at least a portion of the fluid path 10 inside the wedge 3 is substantially or approximately vertical, so that the fluid (in this case, water of the body of water) flows downward at some points in the wedge 3.

The fluid exhaust 6 may be located at a back end 7 of the wedge 3, where a lower pressure is induced by suction caused by first and second flow portions 16, 17 flowing around the wedge 3 (along upper and lower surfaces 12, 14, respectively). Alternatively or in addition, the fluid exhaust 6′ may be located at a distal region (i.e., opposite the wedge point 13) of the lower surface 14, where a lower pressure is induced by the fast moving flow of the second flow portion 17.

The fluid intake 4 may have a width (in a direction perpendicular to the page of FIG. 1a) that spans approximately the entire width of the wedge 3, or only a portion of the width of the wedge 3, such as 10% to 50%. Further, any combinations of engines 8, 9 (such as using one or more of each of tangential fluid engines and axial fluid engines in any order along fluid path 10) is within the scope of the present invention. Further, engines 8, 9 may include any engines capable of extracting power from a fluid having static and/or dynamic pressures (i.e., not moving or moving).

In one embodiment, wedge 3 is pivotable along a vertical axis (vertical as shown in FIG. 1a), such as along the axis of axle 20, to allow the wedge point 13 to be pointed in a direction parallel to but opposite the vector of fluid flow 15, thus maximizing efficiency of the power plant 2.

In operation, the power plant 2 produces electricity in the following manner. Wedge 3 (if rotatable about an axis) is rotated so that wedge point 13 faces a direction that is approximately parallel but opposite to the vector of fluid flow 15. If the angle Θ is adjustable, then at least one of surfaces 12, 14 is adjusted so that the optimal angle Θ is achieved, depending on the flow speed (and perhaps other factors) of the fluid flow 15. Fluid flow 15 is broken into first and second portions 16, 17, by the wedge 3, causing at least one of the portions 16, 17 to speed up relative to fluid flow 15 (due to a reduction in cross sectional area through which a constant mass flow rate of fluid can pass). At least a portion of the first portion 16 enters into fluid intake 4, the portion having a high total pressure (sum of static and dynamic pressures), and first engine 8 extracts power from the fluid and converts the power to rotational power transferred to the electrical generator 19 via axle 20. The fluid continues along the fluid path 10 to second fluid engines 9, in which more power is extracted from the fluid and power is converted to rotational power transferred to the electrical generator 19 via axle 20. Finally, the fluid is exhausted via fluid exhaust 6 (or 6′) into the body of water.

The increase in velocity of the first portion 16 due to the wedge 3 is useful in extracting power from the fluid (and increasing efficiency over a comparable system that does not increase the velocity of the fluid). Further, the suction created at the fluid exhaust 6 (6′) further increases the velocity of the fluid passing through the fluid path 10, thus allowing the system to extract more power and increase efficiency. In other words, in one embodiment, the fluid is “pushed” into the fluid intake 4 at a velocity higher than in the absence of the wedge 3, and “pulled” from the fluid exhaust 6 at a velocity higher than otherwise.

Referring now to FIG. 1b, a power plant 2′ has been modified somewhat. Power plant 2′ is similar to power plant 2 in FIG. 1a, except for the following differences: it includes a wedge 3′ having a funnel 30 that serves as the fluid intake 4′; and a tangential fluid engine may (or may not) be lacking. In this embodiment, at least a portion of the first portion 16 enters into fluid intake 4′ and then immediately funnels downward into the funnel 30 toward fluid engines 9, which may be axial fluid engines. The combination of a high total pressure of the first portion 16 above upper surface 12 and a low pressure at the fluid exhaust 6 (6′) induces a high velocity flow of fluid along fluid path 10′ and through engines 9, allowing power to be extracted and transferred to the electrical generator 19 via axle 20. In this embodiment, fluid flowing along path 10′ may flow approximately vertically at some points.

In one embodiment, one or more fluid engines 9 may be located along the fluid path 10′ in a substantially horizontal region just preceding the fluid exhaust 6.

Referring now to FIG. 1c, a power plant 2″ has been modified somewhat. Power plant 2″ is similar to power plant 2′ in FIG. 1b, except for the following differences: it includes a wedge 3″ having a funnel 30′ that protrudes upward from the upper surface 12 and approaches the Water Level of the body of water; fluid flows into the fluid intake 4″ and takes a fluid path 10″ that may rotate around the inside of funnel 30′ and eventually proceeds downward toward and through engines 9, and finally out fluid exhaust 6 (6′). In FIG. 1c, the fluid flowing into funnel 30′ may take on the form of a cyclone inside the funnel 30′. The funnel 30′ may or may not include ridges or protrusions about the inside of the funnel 30′ that are configured to induce the water to flow in a predetermined fashion. The ridges may take on a screw shape or any other shape.

Referring now to FIG. 2, a power plant 21 comprises a wedge 27 having a plurality of fluid intakes 25, a funnel 28, a plurality of tangential fluid engines 22 each having an approximately vertical axis of rotation, and a plurality of axial fluid engines 24 each having an approximately vertical axis of rotation and located after the funnel 28 along the fluid path. The power plant 21 further comprises a generating station 25 having a plurality of electrical generators 26 connected to engines 22, 24 via axles 23. As shown in FIG. 2, the rotor of exactly one of the tangential fluid engines 22 is directly connected to exactly one electrical generator 26 via exactly one axle 23, the rotor of another one of the tangential fluid engines 22 is directly connected to another one of the electrical generators 26 via another one of the axles 23, and the rotor of another one of tangential fluid engines 22 is directly connected to another one of the electrical generators 26, as well as the rotors of all three axial fluid engines 24, via the remaining axle 23.

In FIG. 2, the plant 21 comprises at least one tangential fluid engine 22 (i.e., the upper two, as shown in FIG. 2) for each of the plurality of fluid intakes 25. Further, the lower tangential fluid engine 22 is located within the funnel 28 to take advantage of the speed of water rotating inside the funnel 28. The axial fluid engines 24 then take advantage of the speed of water flowing downward from the lower portion of the funnel 28.

In operation, at least a portion of water flowing up the upper surface of the wedge 27 enters the fluid intakes 25 at high velocity. The high velocity fluid then impinges tangentially on the cups or blades of each respective tangential fluid engine 22, causing the rotor of each respective tangential fluid engine 22 to rotate, thus powering respective electrical generators 26 via respective axles 23. Next, water flows cyclonically and downward in a predetermined rotation direction within the funnel 28 toward the lower tangential fluid engine 28, which then extracts further energy from the water as the water pushes the cups, blades, etc. of the lower tangential fluid engine 28. The energy extracted by the rotor of the lower tangential fluid engine 22 is transferred to the respective electrical generator 26 via respective axle 23.

Next, water flows downward from the funnel 28 toward the fluid exhaust (not shown) of the wedge 27, passing through a plurality of axial flow engines 24, which extract energy from the downward flow of the water. This energy is transferred to the respective electrical generator 26 via respective axle 23.

Any of the features of FIG. 2 may be mixed, matched, added, or eliminated to suit design requirements. For example, each fluid engine 22, 24 may have its own associated axle 23 and/or electrical generator 26. Alternatively or in addition, any set of fluid engines 22, 24 may share an axle 23 and/or electrical generator 26. For example, in one embodiment, rotors of all fluid engines 22, 24 are directly connected to each other via a single axle 23 that transfers power to the generating station 25. Further, any fluid engine 22, 24 may comprise a gear box or other gearing mechanism to allow for differential preferred rotation rates of the various elements of plant 21—e.g., to allow the rotor of an axial fluid engine 24 to rotate much more quickly than the rotor of an electrical generator 26 to which it is connected.

Further, the plant 21 may include only a single fluid intake 25 or several, and may include only one tangential fluid engine 22 or a plurality, or one axial fluid engine 24 or a plurality, etc. The plant 21 may include any type of fluid engine capable of extracting usable energy from a fluid having dynamic and/or static pressure. Further, the funnel 28 (and/or the lower tangential fluid engine 22 that makes use of the cyclonic fluid flow induced by the funnel 28) may be eliminated or modified. Further, the rotors of any or all of the engines 22, 24 may rotate at different rates.

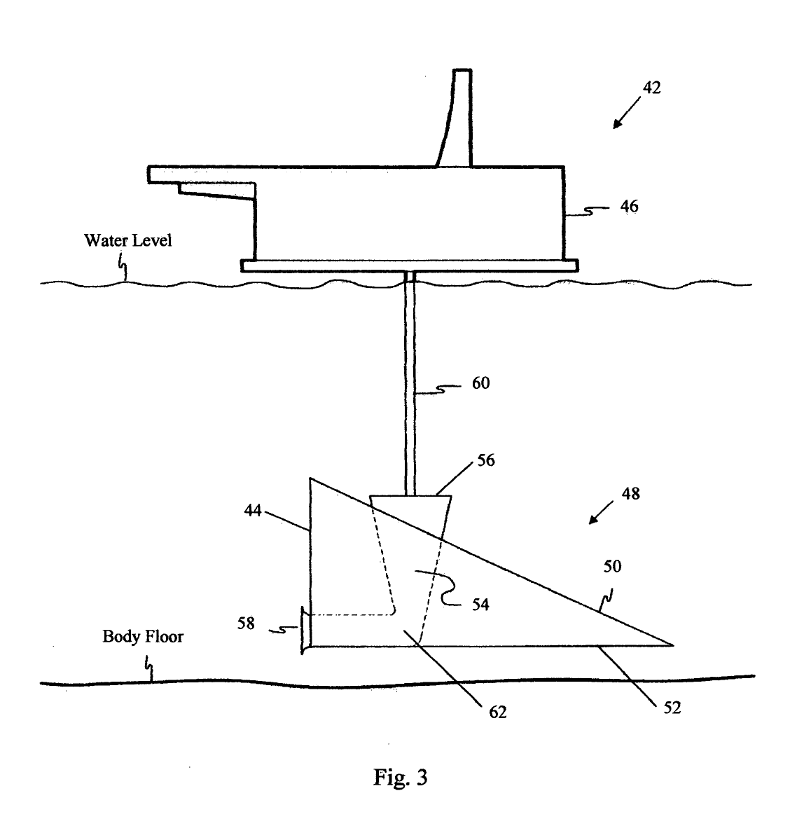

Referring now to FIG. 3, a power plant 42 comprises a generating station 46 and a wedge 48 connected via an axle 60. The wedge 48 comprises an upper surface 50 and a lower surface 52, and a funnel 54 having a fluid intake 56, an elbow 62, and a fluid exhaust 58. The wedge 48 further comprises at least one fluid engine (not shown), which may be located inside the funnel 54, the rotor of which is connected to the axle 60 and transfers power extracted from the moving water to an electrical generator (not shown) inside the generating station 46.

In operation, water flowing toward the wedge point of the wedge 48 divides along the upper and lower surfaces 50, 52, and thus accelerates along these surfaces. Because of the higher velocity of water flowing along surfaces 50, 52 and eventually past the wedge 48, a total fluid pressure along back surface 44 (and at fluid exhaust 58) is lower than the total fluid pressure of the water before reaching the wedge point. Thus, a suction is induced, causing water to be sucked into the fluid intake 56, through the funnel 54 and corresponding fluid engine(s), and out the fluid exhaust 58. Power is extracted from this high velocity fluid and transferred to the generating station 46 via axle 60.

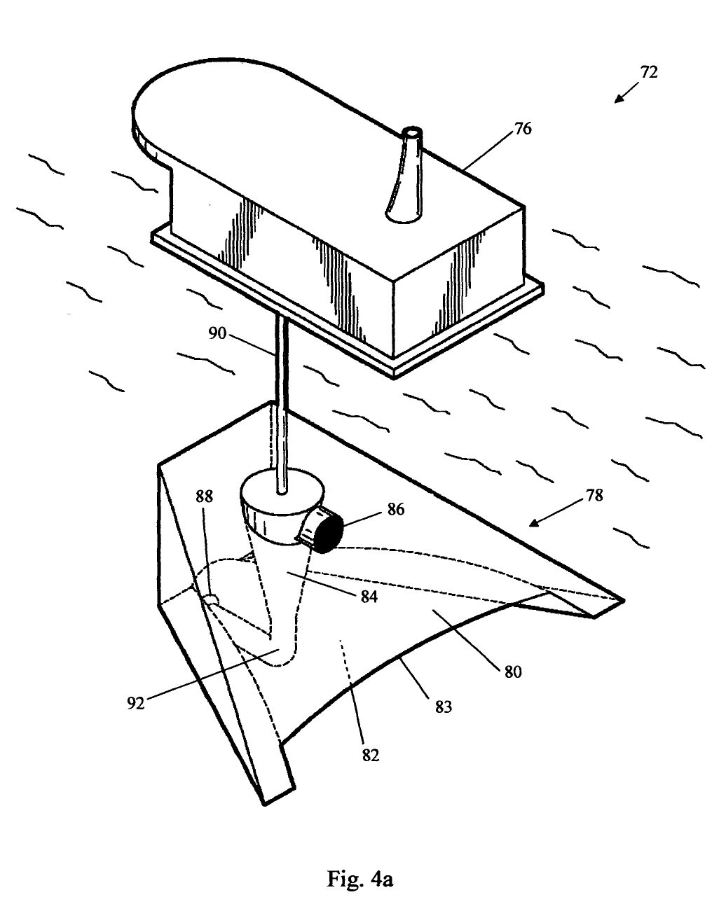

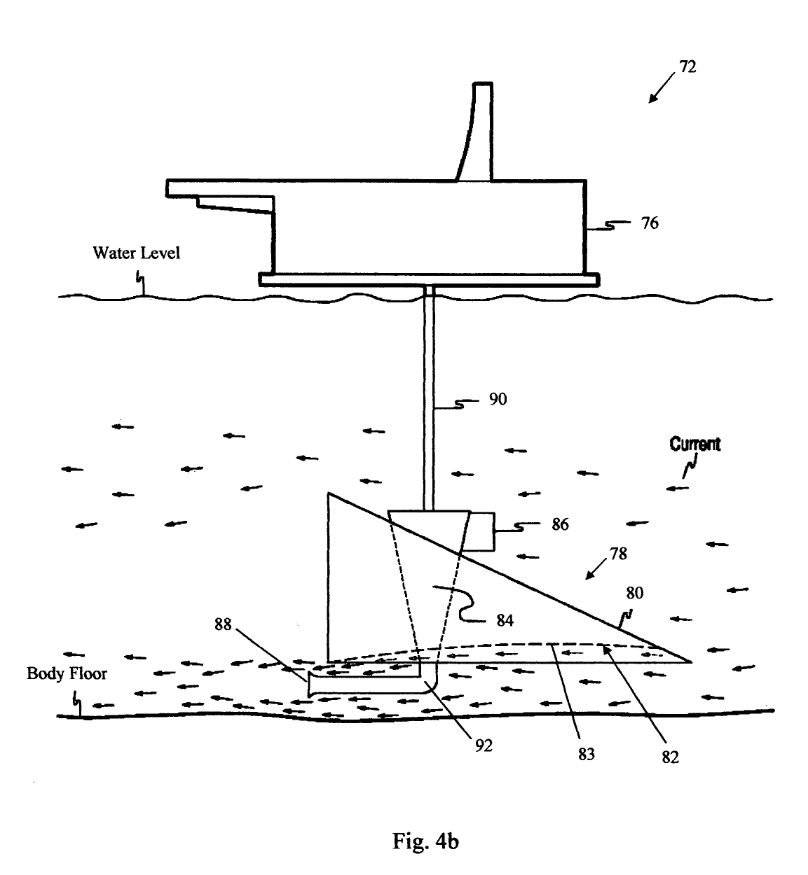

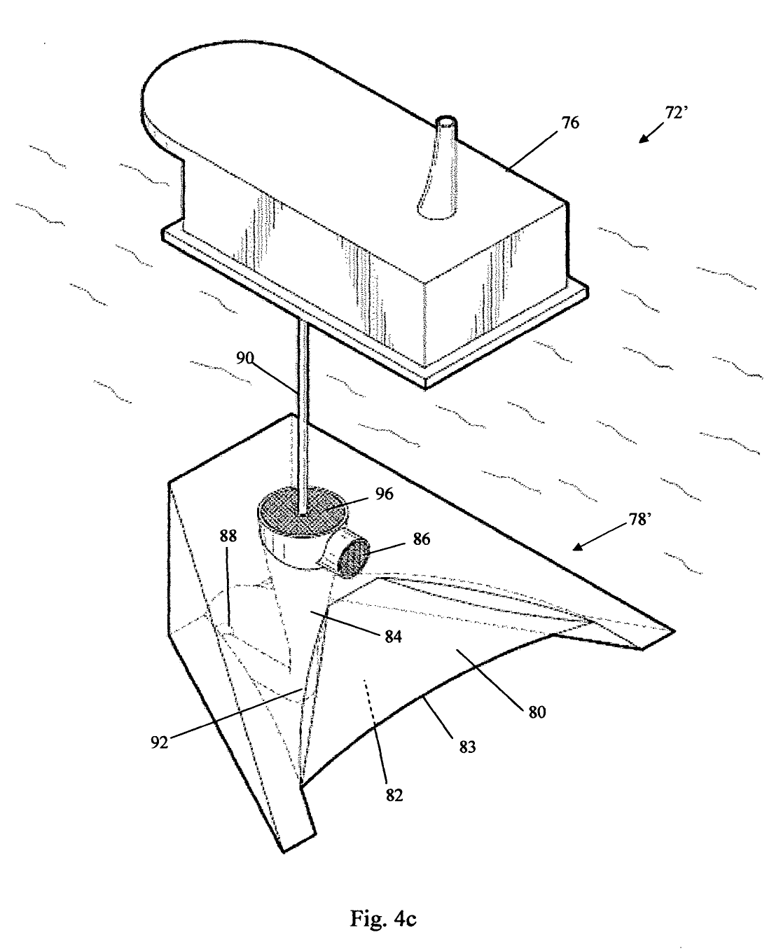

Referring now to FIGS. 4a and 4b, a power plant 72 comprises a generating station 76 and a wedge 78, the wedge 78 having upper and lower surfaces 80, 82 and a funnel 84 having a fluid intake 86, a fluid exhaust 88, an elbow 92, and at least one fluid engine (not shown) connected to the generating station 76 via axle 90. The embodiment shown in FIGS. 4a and 4b is similar to that shown in FIG. 3, with several differences. First, the fluid intake 86 allows approximately horizontally flowing water to flow into a fluid engine (such as a tangential fluid engine) so that the water does not need to substantially change directions before power is extracted from it. Further, the lower surface 82 includes a curvature or contoured shape 83 to help smoothly direct and accelerate the flow of water to and around the fluid exhaust 88. Further, the upper surface 80 may also or alternatively include such a curvature or contoured shape (not shown) to help smoothly direct and accelerate the flow of water into the fluid intake 86. The curvatures (if implemented) may be convex or concave, depending on the design requirements. Either of the embodiments shown in FIG. 3, or 4a/4b may have a smoother elbow than shown, to allow for a more laminar flow of water through the wedge.

Referring now to FIG. 4c, a power plant 72′ is similar to power plant 72 shown in FIG. 4a, including a wedge 78′ similar to wedge 78 in FIG. 4a, with an exception that the wedge 78′ may include, alternatively or in addition, a vertically aligned fluid intake 96 that allows water to flow into funnel 84 (and/or any fluid engine located therein) in an approximately vertical direction.

Finally, FIG. 5 shows one possible embodiment of a suction propeller type fluid engine. The fluid engine 100 comprises an outer casing 102 and a rotor 104 having rotor blades 106. The fluid engine 100 may be located inside any of the funnels discussed with respect to previous embodiments. Thus, the outer casing 102 may or may not correspond to such funnels. The rotor 104 may be connected to an electrical generator via an axle (not shown), and/or may be connected to rotor(s) of other fluid engine(s). In operation, a flow 108 of water from the top of the engine 100 (top as shown in FIG. 5) impinges on blades 106, causing the rotor 104 to rotate. The suction propeller type fluid engine 100 shown in FIG. 5 may be used alone, in conjunction with one or more tangential-type, axial-type, or other known fluid engines, or may be omitted altogether, in any of the power plant embodiments previously discussed.

Most of the embodiments described herein have represented simple versions for clarity of explanation. As understood by one of ordinary skill in the art, many of the features and/or aspects of the embodiments described herein may be “mixed and matched” to the extent physically possible to satisfy individual design requirements. As merely an example of such allowable mixing and matching, an axial fluid engine may be used in place of a tangential flow engine, particularly where a device (as known in the art) is used to change the axis of rotation of the axial fluid engine's rotor (such as allowing a rotor having a horizontal axis to rotate a vertical axis). Any fluid engine known in the art (e.g., Pelton, Francis, Kaplan, etc.) may be used with the present invention. Further, any of the fluid intakes described herein may include a screen or other known device for preventing fish and other debris from entering fluid engines of the power plant. Further, in all embodiments shown, the lower surface is approximately horizontal. However, this need not be the case. For example, the upper surface and lower surface may both be angles with respect to the horizon. For example, the upper surface may be angled positively relative to the horizon at, say, 15°, the lower surface may be angled negatively relative to the horizon at, say, 20°, thus resulting in a relative angle between the upper and lower surfaces to be 35°. The fluid exhaust may exhaust fluid in a direction substantially parallel to a direction of fluid flow along the lower surface (e.g., see FIGS. 3 and 4b), or may exhaust the fluid in a direction substantially angled with respect to the direction of fluid flow along the lower surface (e.g., exhaust 6′ in FIG. 1b).

As another example, the word “wedge” as used herein is not limited to an object having two flat surfaces that are angled with respect to each other, or an object that is perfectly triangular in cross section. Both upper and lower surfaces (e.g., 12 and 14 in FIG. 1a) may be curved, contoured, rounded, or shaped other than as flat surfaces. More generally, a “wedge” used herein is a device used to separate fluid flow 15 (FIG. 1a) into first and second flow portions, and preferably reduces or limits turbulence that may arise from such separation. In other words, preferably, the wedge divides the fluid flow 15 into two portions having substantially smooth or laminar flow. The wedge may, for example, be an incline. As one possible example in which at least one surface of the wedge is not flat, the upper surface may be curved concave so that angle Θ is very shallow (e.g., less than 5° or 10°) near the wedge point 13, and increases (e.g., to greater than 30°) further from the wedge point.

As another example, one or more fluid engines may be located in a substantially horizontal region just preceding (in the fluid path 10′ in FIG. 1b) the fluid exhaust 6. In other words, instead of or in addition to fluid engines 9 being located in a substantially vertical region of the fluid path 10′, fluid engines may be located in a substantially horizontal region of the fluid path 10′. As another example, the portion of the fluid path (e.g., 10 in FIG. 1a) that is substantially vertical may, e.g., be at an angle of between 75° and 105° with respect to the body floor.

The present invention also includes a method of generating electricity, including providing any of the power plants described herein and inserting said plant(s) into a body of water, such as an ocean, a lake, a river, a sea, or any other body of water. The method may include selecting a body of water and a location within the body such that a ratio of a height of the wedge (h in FIG. 1a) relative to a depth of the body (d in FIG. 1a) falls within a particular range, such as approximately 20% to 80%, and more preferably 30% to 70%, and more preferably 40% to 60%, and more preferably approximately 50%. The method may include inserting the plant(s) into the water body such that the lower surface is approximately flush with, or at least approximately 10 feet above, or at least approximately 20 feet above, or at least approximately 30 feet above, the floor of the water body. The method may include placing the generating station above the water level of the water body.

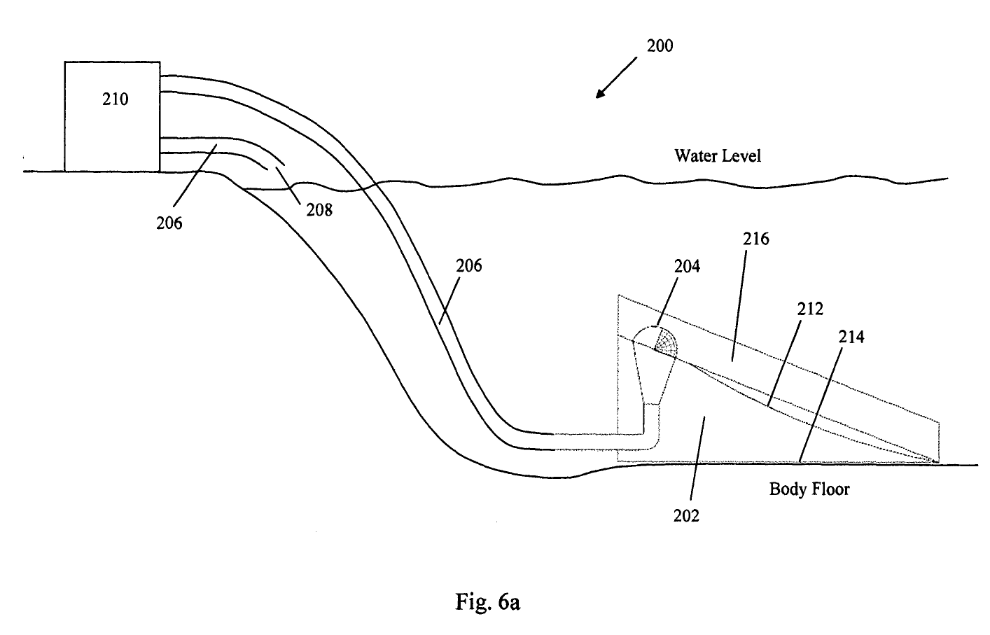

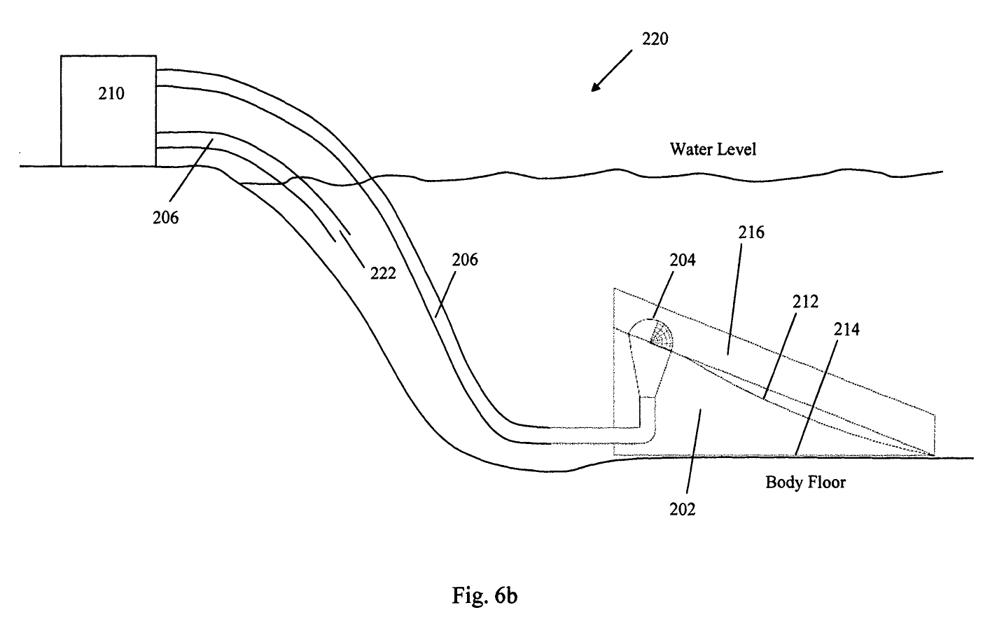

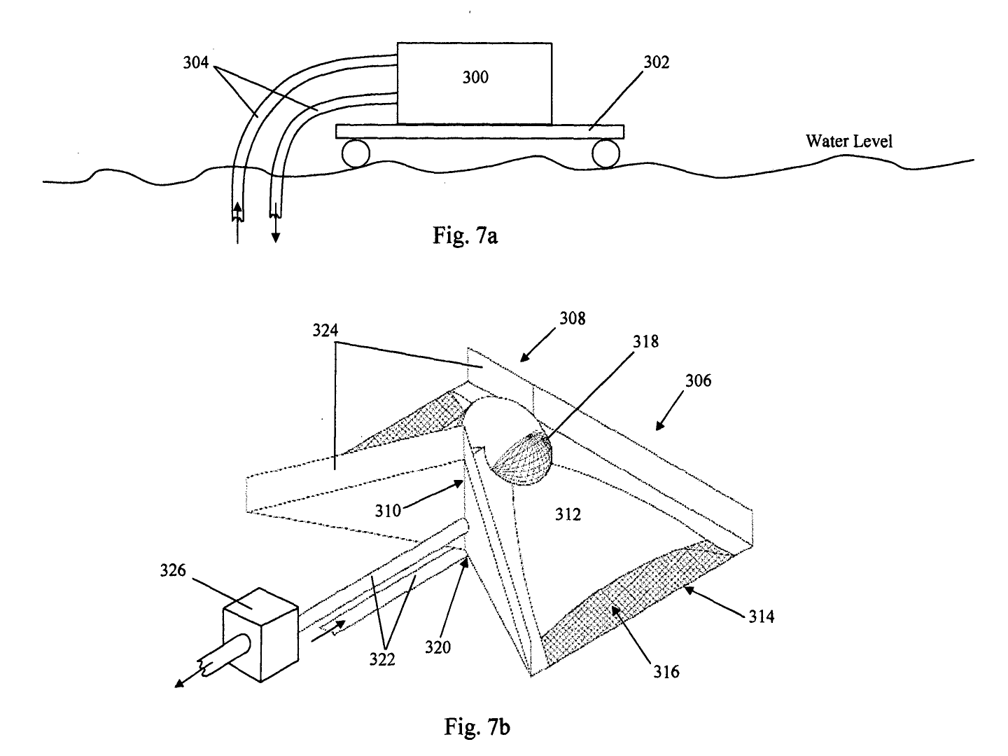

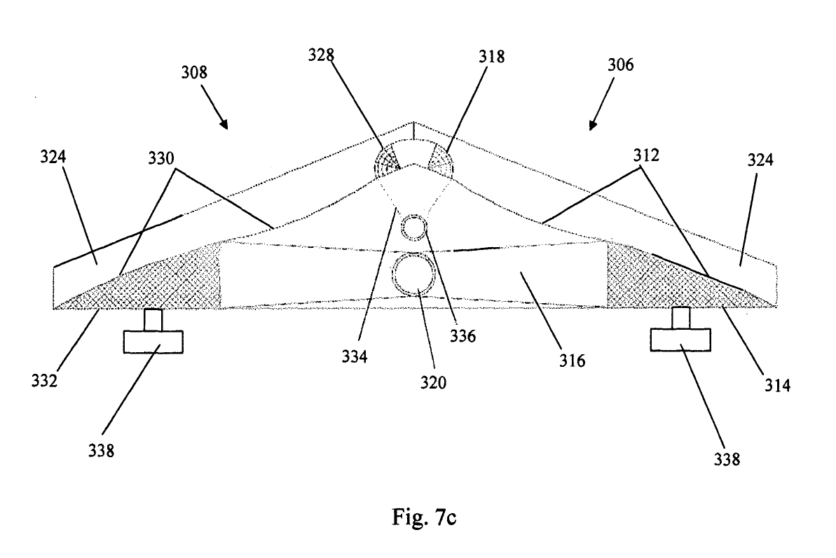

Referring now to FIG. 6a, a hydroelectric power plant 200 comprises a wedge 202 comprising a fluid intake 204, and a fluid engine 210 located in a fluid path 206 between the fluid intake 204 and a fluid exhaust 208. The wedge 202 comprises upper surface 212 and lower surface 214, and the surfaces 212, 214 may be angled with respect to each other by at least approximately 15° or any of the angles or angle ranges previously mentioned. The wedge 202 is shaped to receive a fluid flow in the fluid intake 204. The wedge 216 includes a flow constriction device 216, which is configured to increase a velocity of the fluid flow into the fluid intake 204. The flow constriction device 216 includes any device known in the art for constricting the flow of a fluid, and may include two sides 216 connected to the upper surface 212 and extending above the upper surface 212. The sides 216 may taper toward each other in a direction approaching the fluid intake 204, as shown, for example, with reference to FIG. 7b. Further, the flow constriction device 216 (e.g., sides 216) may be configured to be adjusted and/or raised and lowered to allow a desired amount of flow constriction to take place. For example, sides 216 may be mounted on a track system, allowing the sides 216 to move up and down, and may be controlled and moved using a motor, gear, and electronic control system (not shown), as understood by one of ordinary skill in the art. Alternatively or in addition, the sides 216 may be movable inward and outward like flaps on an airplane, and/or their degree of tapering may be adjustable.

Flow intake 204 is shown with an approximately hemispherical shape, with a guard, screen, or net covering a portion facing the incoming fluid flow, for example to prevent the introduction of impurities and other unwanted objects in the fluid flow. In the embodiment shown in FIG. 6a, wedge 202 is located such that the lower surface 214 is approximately flush with the Body Floor of the body of water. Further, fluid engine 210 is located on land, above the Water Level of the body of water. Further, fluid exhaust 208 is located above the Water Level of the body of water. Further, upper surface 212 (or lower surface 214 or both) may be curved or contoured, as shown, to allow for a more laminar flow of fluid along the upper surface 212 of the wedge 202.

However, in alternative embodiments, any or all of these features may be changed. For example, the lower surface 214 of the wedge 202 may be located above the Body Floor of the body of water, in any of distances or ranges previously mentioned. Further, fluid engine 210 may be located within the water or, in an embodiment discussed with reference to FIG. 7a, may be located above the water on a floating or permanent platform. Further, the exhaust 208 may be located in several places, such as remotely from the wedge 202, in or out of the water, in the same or different body of water, up current or down current from the wedge 202, and so forth. For example, referring now to FIG. 6b, a hydroelectric power plant 220 is similar to the plant 200 shown in FIG. 6a, with common reference numbers indicating common features. The plant 220 includes a fluid exhaust 222 that is located in the body of water, remotely from the wedge 202.

In operation of the plant 200 shown in FIG. 6a, upper surface 212 of wedge 202 causes current in the body of water to rise up toward the fluid intake 204. The reduced cross sectional area through which fluid can flow causes the fluid to increase in velocity. Flow constriction device 216 further increases the velocity of the fluid as it enters the fluid intake 204. The high velocity fluid then flows through fluid path 206 to fluid engine 210, where energy in the fluid is transferred to usable energy via any of the methods and devices previously discussed, such as using a turbine or piston engine other fluid engine (which energy can then be transferred to electrical energy by an electrical generator, etc.), and then continues along fluid path 206 to fluid exhaust 208, where the fluid is discharged back into the body of water.

Referring now to FIGS. 7a and 7b, a hydroelectric power plant includes a fluid engine 300 located on a platform 302 located above the Water Level (the platform 302 may be a floating platform or a permanent platform that is connected to the Body Floor), and a double wedge system having a first wedge 306 and a second wedge 308. Each of the wedges 306, 308 has a back (both generally designated by reference number 310), with the backs 310 connected to each other. The first wedge 306 includes upper surface 312 and lower surface 314 (either or both of which may be contoured), and may be angled relative to each other in any way previously described (such as at least 15°, and preferably between 30° and 60°, etc.). The wedge 306 may further include a fluid intake 318, a flow constriction device 324, and a fluid accelerating device 316 (better shown with reference to FIG. 7c). The second wedge 308 has features similar to and corresponding to the first wedge 306. (Referring to FIG. 7c, the second wedge 308 includes fluid intake 328, upper surface 330, and lower surface 332.) Fluid intakes 318, 328 (for both the first and second wedges 306, 308) and a fluid exhaust 320 may be connected via a fluid path 322, along which may include a pump 326 configured to increase a velocity of fluid traveling to the fluid engine 300. Fluid paths 304 and 322 are connected to ultimately connect the fluid engine 300 to the double wedge system. The pump 326 may be any pump known in the art, including a centrifugal pump, and may be configured to increase the velocity of a portion of the fluid flow at the expense of reducing the velocity of another portion of the fluid flow. For example, the pump 326 may be powered at least in part by converting energy from a part of the fluid flow into additional kinetic energy given to a different part of the fluid flow. Pump 326 may or may not be located inside one or more of the wedges 306, 308.

Referring now to FIG. 7c, the double wedge system shown in FIG. 7b further includes a region 334 in which at least a portion of the fluid flow is approximately vertical, a fluid exhaust 320 in which fluid from the fluid engine flows out, as well as a conduit 336 from the fluid intakes 318, 328 to the fluid engine via the flow paths 322, 304. The region 33 may or may not have a conical or siphon shape to direct fluid flow downward. The system may further include height adjustment devices 338 configured to enable raising and lowering of the wedges 306, 308. The devices 338 may use any technology known in the art, including but not limited to hydraulic, electric, and pneumatic lifts. The fluid accelerating devices 316, which are located adjacent to the fluid exhaust 320, are configured to accelerate fluid near the fluid exhaust 320 to provide further suction to suck fluid from the fluid exhaust 320. In FIG. 7c, fluid intakes 318, 328 are shown connected to fluid exhaust 320 via a common flow path 322, but in another embodiment the fluid intake 318 may be connected to its fluid exhaust by a different flow path than that connecting the fluid intake 328 with its fluid exhaust. An advantage to the double wedge system shown in FIGS. 7b and 7c is that a single system may take advantage of opposing flow directions resulting from, e.g., ocean tides.

In operation, assuming fluid flow is initially toward the left in FIG. 7c (due, e.g., to a tide), a portion of water flow moving toward wedge 306 flows left upward along the upper surface 312 of first wedge 306, and a portion flows into fluid accelerating device 316. The upper portion is accelerated by the reduced cross sectional flow area of both the slope of the upper surface 312 as well as flow constriction device 324, and enters the fluid intake 318, where it travels to fluid engine 300 via region 334, fluid flows 322, 304, and pump 326. The fluid engine 300 the extracts some of the fluid's energy, and then returns the fluid to the fluid exhaust 320 via fluid flows 322, 304. The fluid from fluid accelerating device 316 moves past the fluid exhaust 320, and sucks the fluid out in a direction of the fluid accelerating device 316 of the second wedge 308. If and when the tide or current direction reverses, a similar process happens, this time with fluid entering fluid intake 328 via upper surface 330 of the second wedge 308, and with fluid being exhausted via fluid exhaust 320 in a direction of the fluid accelerating device 316 of the first wedge 306. Of course, all of the fluid eventually is exhausted back into the body of water.

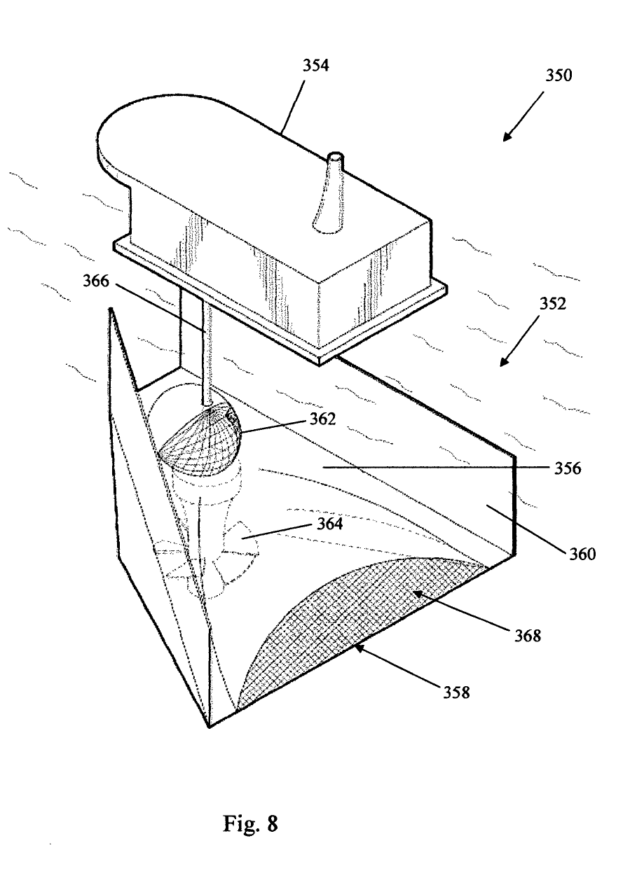

Referring now to FIG. 8, a hydroelectric power plant 350 includes an electrical generator 354 and wedge 352 having an upper surface 356, a lower surface 358, a fluid constricting device 360, a fluid intake 362, a Francis turbine or other fluid engine 364 located inside the wedge 352 and connected to the generator 354 via a shaft 366, and a fluid accelerating device 368 for accelerating fluid past the fluid exhaust (not shown).

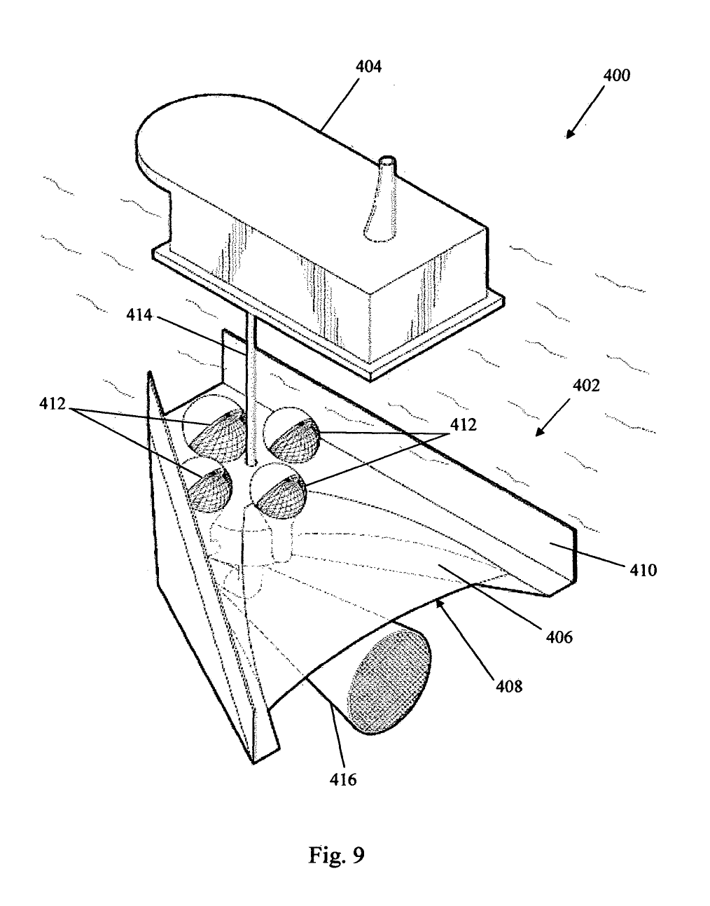

Referring now to FIG. 9, a hydroelectric power plant 400 includes an electrical generator 404 and a wedge 402 including an upper surface 406, a lower surface 408, a fluid constriction device 410, a plurality of fluid intakes 412, a shaft 414 connecting a fluid engine (not shown) to the generator 404, and a fluid accelerating device 416 adjacent to the fluid exhaust (not shown) configured to accelerate fluid past the fluid exhaust to provide further suction. The fluid accelerating device 416 may be approximately shaped as a portion of a cone, and/or may have an approximately circular cross section.

The invention may include further features. For example, the fluid engine may be located internally or externally to the wedge. An advantage to external location, particularly on land or on an above-water platform, is that corrosion can be limited or controlled. Further, the fluid exhaust may be located at, near, or remote to the wedge, even possibly in a different body of water, and in or out of water. Further, a plurality of wedges in series (i.e., one after the other in the direction of fluid flow) or parallel (i.e., parallel with respect to the fluid flow) may be used to extract even more power out of a fluid flow. The intakes of these wedges may all be connected to a single fluid engine via a common fluid flow, or a plurality of fluid engines may be used. The present invention may be used with fluid flows in oceans, lakes, tidal basins, rivers, and other bodies of water. In many of the embodiments, at least a portion of the fluid flow is approximately vertical, so as to take advantage of the “falling” of water that occurs after the water has been lifted along the upper surface of the wedge. The energy of the increased velocity of the flow due to the wedge may be extracted by other means than by falling, so a vertical portion is not a requirement for all embodiments of the present invention. In an embodiment, a hydroelectric plant may include a plurality of wedges, each wedge comprising a fluid intake, such as at least two wedges as shown in FIG. 7c. Alternatively or in addition, the plant may include a plurality of fluid engines, each fluid engine located in a fluid path between a fluid intake and a fluid exhaust, such as shown with reference to FIG. 2. Each wedge may have its own fluid engine, fluid intake, and fluid exhaust, or one or more of these features may be shared among more than one wedge. (For example, as shown in FIGS. 7a-7c, two wedges 306, 308 may share a common fluid engine 300 and a common fluid exhaust 320.) In an embodiment, the plant may include many, such as at least ten, wedges, each wedge having its own fluid intake and fluid engine. The wedges may or may not be connected in series or parallel.

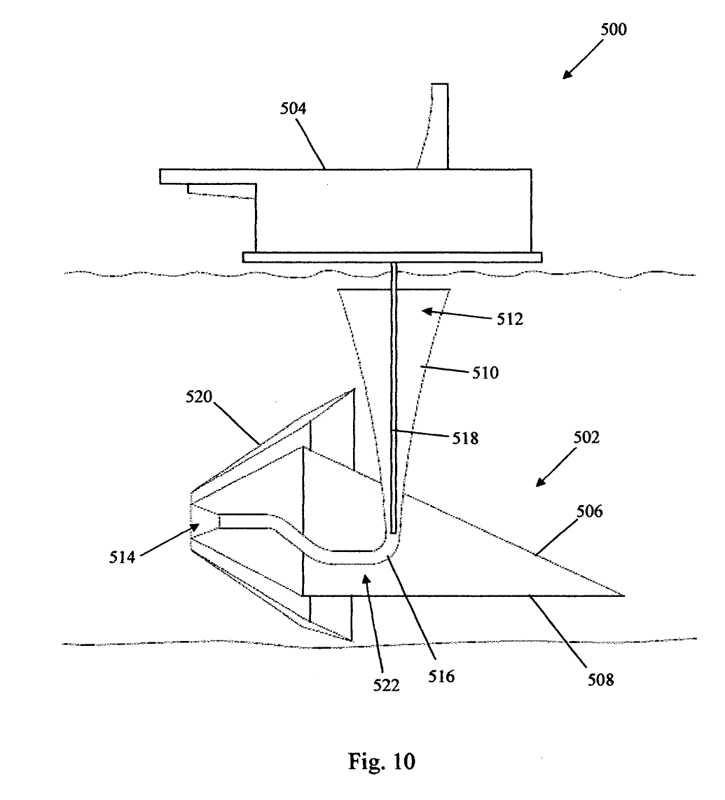

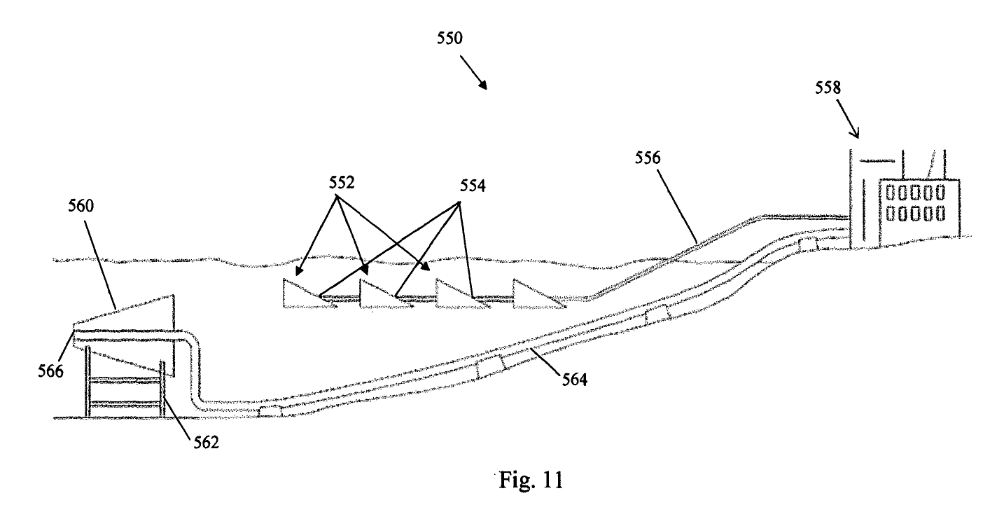

Referring now to FIG. 10, a hydroelectric power plant 500 includes a wedge 502 and an electrical generator 504 (shown in FIG. 10 as being above water, such as floating or on land), the wedge 502 having upper surface 506 and lower surface 508. The plant 500 includes a funnel 510 that funnels water from fluid intake 512 to fluid exhaust 514 via fluid path 516. A fluid engine (not explicitly shown in FIG. 10) is located in fluid path 516 and transfers rotational kinetic energy to electrical generator 504 via shaft 518. The plant 500 includes a fluid accelerating device 520 located adjacent to fluid exhaust 514 and configured to accelerate fluid past the fluid exhaust 514. The fluid accelerating device 520 is shown in FIG. 10 to be approximately shaped as a portion of a cone, and located directly adjacent to the wedge 502. Further, fluid path 516 includes an inverted siphon 522.

Referring now to FIG. 11, a hydroelectric power plant 550 comprises a plurality of wedges 552 and a plurality of fluid intakes 554, each wedge 552 located adjacent to at least one of the fluid intakes 554. The wedges 552 may each comprise at least upper and lower surfaces, the surfaces angled with respect to each other by at least approximately 15°. The plant 550 further comprises a fluid exhaust 566 and a fluid accelerating device 560 located adjacent to the fluid exhaust 566 and configured to accelerate fluid past the fluid exhaust 566. The fluid accelerating device 560, which may be supported on support 562, may be approximately shaped as a portion of a cone, and may be located remotely from the wedges 552. The plant 550 further comprises at least one fluid engine (not shown) located in a fluid path between the fluid intakes 554 and fluid exhaust 566. There could, but need not, be a fluid engine associated with each wedge 552. The fluid path may comprise conduit 556 and conduit 564, and conduit 564 may comprise an inverted siphon. The fluid engine may power an electrical generator 558 that may be on land. Alternatively, the plant 550 may include a plurality of fluid accelerating devices 560, each device 560 approximately shaped as a portion of a cone. Alternatively, one or more fluid accelerating devices 560 is configured to accelerate fluid, but is not shaped as a portion of a cone.

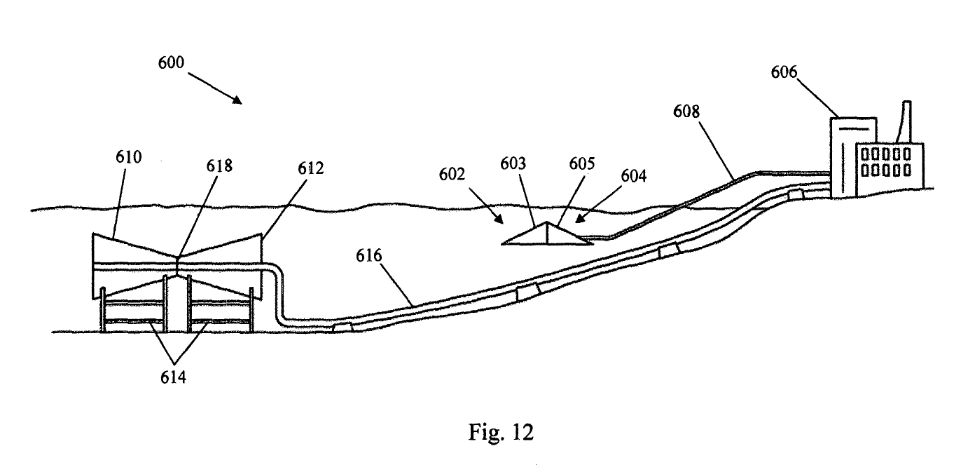

Referring now to FIG. 12, a hydroelectric power plant 600 includes a first wedge 602 having a first fluid intake 603 and a second wedge 604 having a second fluid intake 605 comprising a back connected to a corresponding back of the first wedge 602. The plant further comprises a fluid exhaust 618, a first fluid accelerating device 610, and a second fluid accelerating device 612 comprising a back connected to a corresponding back of the first fluid accelerating device 610, each fluid accelerating device 610, 612 located adjacent to the fluid exhaust 618 and configured to accelerate fluid past the fluid exhaust 618. The fluid accelerating devices 610, 612, which may be supported by support 614, may each be approximately shaped as a portion of a cone, and may be located remotely from the wedges 602, 604. The plant 600 further comprises at least one fluid engine (not shown) located in a fluid path between the fluid intakes 603, 605 and fluid exhaust 618. There could, but need not, be a fluid engine associated with each wedge 602, 604. The fluid path may comprise conduit 608 and conduit 616, and conduit 616 may comprise an inverted siphon. The fluid engine may power an electrical generator 606 that may be on land.

The embodiment shown in FIG. 12 may be especially suited for bodies of water in which tidal forces cause change in flow directions. For example, the first wedge 602 and first fluid accelerating device 610 may be primarily in operation when the flow of water is to the right in FIG. 12, and second wedge 604 and second fluid accelerating device 612 may be primarily in operation when the flow of water is to the left in FIG. 12. Alternatively or in addition, at least one of the wedges 602, 604 and/or fluid accelerating devices 610, 612 may comprise a pivot about which it may rotate, such as to accommodate change in flow direction in the body of water.

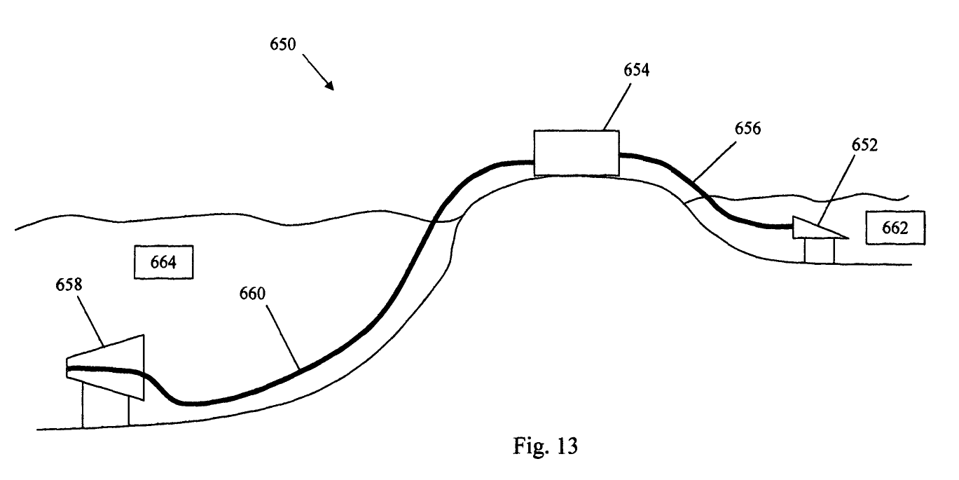

Referring now to FIG. 13, a hydroelectric power plant 650 comprises a wedge 652 located in a first body of water 662, a fluid accelerating device 658 located in a second body of water 664 different than the first body of water 662 (such that the fluid accelerating device 658 is located remotely from the wedge 652), a fluid engine (not shown) located in a fluid path between a fluid intake and a fluid exhaust, the fluid path including conduit 656 and inverted siphon 660, and an electrical generator 654 that may include the fluid engine. Of course, any of the features described previously may be incorporated into the embodiment shown in FIG. 13. Further, as shown in FIG. 13, the fluid accelerating device 658 may have been inserted into the second body of water 664 more deeply than the wedge 652 was inserted into the first body of water 662.

In various other aspects, the first body of water 662 may be a city wastewater reservoir. Water traveling through conduit 656 and inverted siphon 660 may be treated water, such as with chlorine, which may help to eliminate any buildup in inverted siphon 660. Alternatively or in addition, the land over which the fluid path in FIG. 13 travels may be very long, such as many miles, and a significant portion (e.g., more than half, or even more than 90%) of the length of inverted siphon 660 may be over land. Further, one or both (or portions) of conduit 656 and inverted siphon 660 may be buried in the ground.

As another example, for the intake, engineers could dredge a base and bury the base of the inverted siphon inside the concrete base. The wedge could pivot and the engineers could bury the conduits and/or fluid paths to the onshore plant. The inverted siphon may be buried also. The motor for pivoting the wedge and/or adjusting the incline may be in a watertight module in the concrete base. The adjusting and pivoting of the wedge may be done by gears. For maintenance, a floatation device (such as an inflatable device) could be installed in the wedge and/or fluid accelerating device. By pressing a button to activate the floatation device, the wedge and/or device can then rise to the surface guided by cables attached to the concrete base and controlled by winches on a barge above.

Any of the features described with respect to any of the embodiments herein may be applied, where possible, to any other disclosed embodiment. For example, the wedge 502 in FIG. 10 (or wedges 552 in FIG. 11, etc.) may include the flow constriction device 324 shown, e.g., in FIG. 7b.

The fluid accelerating device, such as in the shape of part of a cone, and other features of the present invention work at least partially on the concept of the Bernoulli effect, which states that the sum of static pressure and dynamic pressure remain constant in an incompressible fluid (such as water). As dynamic pressure increases (such as due to an increase in velocity), then static pressure decreases, creating a sort of “suction” effect relative to lower-velocity regions of the fluid. The present application includes applications of the Bernoulli effect as known by one of ordinary skill in the art.

Further, an inverted siphon, such as 564 in FIG. 11, 616 in FIG. 12, and so forth, refers to conduits that form a “U” shaped flow path. The siphon effect may not come into play, as liquid flowing in one end simply forces liquid up and out the other end. Engineers must ensure that the flow rate in such a channel is fast enough to keep suspended solids from settling, otherwise the inverted siphon may tend to act as a debris trap. This is especially important in sewage systems which must be routed under rivers or other deep obstructions.

Every hydroelectric site or power plant may be different. Some may require offshore platforms and some may require onshore plants. Some require siphons and down current exhausts. Some require a plurality of wedges. Some require offshore platforms, some require onshore turbines. By mixing and matching a plurality of four simple machines (a wedge, a flow constriction device, an inverted siphon, and a cone accelerated exhaust), a push-pull effect is created within the siphon which powers a turbine (or other fluid engine) within the fluid path.

Further, in one aspect of the present invention, a wedge may be lowered from a surface into a fluid flow, in a manner similar to a boat outboard engine or a kitchen food mixer being lowered into a bowl. Further, in one aspect of the present invention, a cone exhaust, wedge, and/or fluid accelerating device could be lowered from the bottom of a cruise ship or navy vessel and could be used to charge batteries.

What is claimed is:

1. A hydroelectric power plant, comprising:
a fluid intake;
a fluid exhaust;
a fluid engine located in a fluid path between the fluid intake and the fluid exhaust; and
a fluid accelerating device located adjacent to the fluid exhaust and configured to accelerate fluid past the fluid exhaust,
wherein the fluid accelerating device is approximately shaped as a portion of a cone.

2. The hydroelectric power plant as claimed in claim 1, wherein the hydroelectric power plant comprises a plurality of fluid exhausts and a plurality of fluid accelerating devices, each fluid accelerating device approximately shaped as a portion of a cone and located adjacent to at least one of the plurality of fluid exhausts.

3. The hydroelectric power plant as claimed in claim 1, further comprising a wedge located adjacent to the fluid intake,
wherein the wedge comprises at least upper and lower surfaces, the upper and lower surfaces angled with respect to each other by at least approximately 15°.

4. The hydroelectric power plant as claimed in claim 3, wherein the wedge further comprises a flow constriction device configured to increase a velocity of the fluid flow, wherein the flow constriction device comprises at least two sides connected to the upper surface and extending above the upper surface, wherein the at least two sides taper toward each other in a direction approaching the fluid intake.

5. The hydroelectric power plant as claimed in claim 3, wherein the fluid accelerating device is located directly adjacent to the wedge.

6. The hydroelectric power plant as claimed in claim 3, wherein the fluid accelerating device is located remotely from the wedge.

7. The hydroelectric power plant as claimed in claim 1, wherein the fluid path comprises an inverted siphon.

8. The hydroelectric power plant as claimed in claim 1, further comprising a second fluid accelerating device comprising a back connected to a corresponding back of said fluid accelerating device and configured to accelerate fluid past the fluid exhaust,
wherein the second fluid accelerating device is approximately shaped as a portion of a cone.

9. A hydroelectric power plant, comprising:
a fluid intake;
a fluid exhaust;
a wedge located adjacent to the fluid intake, the wedge comprising at least upper and lower surfaces, the upper and lower surfaces angled with respect to each other by at least approximately 15°;
a fluid accelerating device located adjacent to the fluid exhaust and configured to accelerate fluid past the fluid exhaust; and
a fluid engine located in a fluid path between the fluid intake and the fluid exhaust,
wherein the wedge comprises a flow constriction device configured to increase a velocity of the fluid flow,
wherein the flow constriction device comprises at least two sides connected to the upper surface and extending above the upper surface, and
wherein the at least two sides taper toward each other in a direction approaching the fluid intake.

10. The hydroelectric power plant as claimed in claim 9, wherein the hydroelectric power plant comprises a plurality of fluid exhausts and a plurality of fluid accelerating devices, each fluid accelerating device located adjacent to at least one of the plurality of fluid exhausts, and a plurality of fluid intakes and a plurality of wedges, each wedge located adjacent to at least one of the fluid intakes.

11. The hydroelectric power plant as claimed in claim 9, wherein the fluid accelerating device is located directly adjacent to the wedge.

12. The hydroelectric power plant as claimed in claim 9, wherein the fluid accelerating device is located remotely from the wedge.

13. The hydroelectric power plant as claimed in claim 9, wherein the fluid path comprises an inverted siphon.

14. The hydroelectric power plant as claimed in claim 9, further comprising a second fluid accelerating device comprising a back connected to a corresponding back of said fluid accelerating device and configured to accelerate fluid past the fluid exhaust.

15. A method of generating electricity, comprising:
providing a hydroelectric power plant, the plant comprising:
a fluid intake;
a fluid exhaust;
a wedge located adjacent to the fluid intake;
a fluid accelerating device located adjacent to the fluid exhaust and configured to accelerate fluid past the fluid exhaust; and
a fluid engine located in a fluid path between the fluid intake and the fluid exhaust,
wherein the wedge comprises at least upper and lower surfaces, the upper and lower surfaces angled with respect to each other by at least approximately 15°;
inserting the wedge into a first body of water; and
inserting the fluid accelerating device into a second body of water different than the first body of water.

16. The method of generating electricity as claimed in claim 15, wherein the fluid accelerating device is approximately shaped as a portion of a cone.

17. The method of generating electricity as claimed in claim 15, wherein the hydroelectric power plant comprises a plurality of fluid accelerating devices, each fluid accelerating device approximately shaped as a portion of a cone.

18. The method of generating electricity as claimed in claim 15, wherein the hydroelectric power plant comprises a plurality of wedges, each wedge comprising at least upper and lower surfaces, the upper and lower surfaces angled with respect to each other by at least approximately 15°.

19. The method of generating electricity as claimed in claim 15, further comprising inserting the fluid accelerating device into the second body of water more deeply than the wedge is inserted into the first body of water.

20. The method of generating electricity as claimed in claim 15, further comprising rotating at least one of the fluid accelerating device and wedge to account for a flow direction in the first or second body of water.
